(19) United States
(12) Patent Application Publication
(10) Pub. No.: US 2014/0320758 A1
(43) Pub. Date: Oct. 30, 2014

(54) TOUCH PANEL

(71) Applicant: Quanta Computer Inc., Taoyuan Shien (TW)

(72) Inventors: Chee-Chun LEUNG, Taoyuan Shien (TW); Ching-Chih CHEN, New Taipei City (TW); Chien-Yu YI, Zhongli City (TW); Chiung-Lun LIN, Hsinchu City (TW)

(73) Assignee: Quanta Computer Inc., Taoyuan Shien (TW)

(21) Appl. No.: 14/067,859

(22) Filed: Oct. 30, 2013

(30) Foreign Application Priority Data
Apr. 24, 2013 (TW) 102114612

(51) Int. Cl. G02F 1/1333

(52) U.S. Cl. CPC G02F 1/13338
USPC 349/12

(57) ABSTRACT

Disclosed herein is a touch panel, which includes a first sensing substrate, a second sensing substrate and an anisotropic conducting film. The first sensing substrate includes at least one first sensing series, at least one first signal transmission line, and at least one second signal transmission line. The first sensing series extends in a first direction. The first signal transmission line is connected to the first sensing series. The second substrate faces the first substrate, and comprises at least one second sensing series extending in a second direction crossed with the first direction. The anisotropic conducting film is disposed between the first sensing substrate and the second sensing substrate, and is electrically connected to the second signal transmission line and the second sensing series.

### CROSS-REFERENCE TO RELATED APPLICATIONS

This application claims priority to Taiwan Application Serial Number 102114612, filed Apr. 24, 2013, which is herein incorporated by reference.

### FIELD OF THE INVENTION

The present disclosure relates to a panel, and more particularly, to a touch panel.

### BACKGROUND

With the development of electronic product design increasingly oriented towards the users, taking the user operating convenience into consideration, electronic products with touch panels has gradually become the mainstream on the market. For example, touch panel is an important part in smart phones or tablet computers. Currently, touch panels can be classified in resistive, capacitive, optical and electromagnetic touch panels. In comprehensive consideration of today's market and technical maturity, capacitive touch panels are the most widely applied among these kinds touch panels. In the structure design of capacitive touch panels, OGS (one-glass solution) and G1F (glass-film) are two kinds of newer technologies.

In OGS, both directions of horizontal and vertical capacitive sensing electrodes are fabricated on the same glass substrate to mutually sense the touch signals. In contrast, in G1F, only the one direction (horizontal or vertical) of capacitive sensing electrodes are fabricated on a glass substrate, and the other direction (vertical or horizontal) of capacitive sensing electrodes is fabricated on a thin film, then the glass substrate and the thin film are combined as the capacitive touch panel. In view of the current technological level of development, G1F has received a considerable degree of attention and become main direction of research and development in touch panel technology.

However, as aforementioned, since the capacitive sensing electrodes in two directions are respectively fabricated on different substrates, a flexible circuit board is required to connect said electrodes on different surfaces. It results in a complicated process in touch panel manufacturing and also increases the area of the flexible circuit board. Therefore, an optimization on structure design of a touch panel is aggressively studied to solve this issue.

### SUMMARY

The present disclosure relates to a touch panel, which has a special layout design and novel combination structure, to integrate the touch sensing series on opposite substrates. Therefore, the touch sensing signals of the touch sensing series on opposite substrates can be controlled by the signal transmission lines on only one of the opposite substrates. Accordingly, the single-side flexible circuit board is required. According to one embodiment of the present disclosure, not only the high strength of glass substrate is retained as conventional G1F structure, but also eliminate the concern of applying a flexible circuit board with complicated structure. Hence, the cost of manufacturing a touch panel can be further reduced.

The present disclosure relates to a touch panel comprises a first sensing substrate, a second sensing substrate, and a first anisotropic conducting film. The first sensing substrate has a detecting region and a peripheral area surrounding the detecting region, and the first sensing substrate comprises at least one first sensing series, at least one first signal transmission line, and at least one second signal transmission line. The first sensing series is disposed in the detecting region, and the first sensing series extends in a first direction. The first signal transmission line is disposed in the peripheral area, and is connected to the first sensing series. The second signal transmission line is disposed in the peripheral area. The second sensing substrate is opposite to the first sensing substrate. The second sensing substrate comprises a least a second sensing series. The second sensing series extends in a second direction, wherein the second direction crosses the first direction. The first anisotropic conducting film is disposed between the first sensing substrate and the second sensing substrate, and positioned in the peripheral area to electrically connected to the second signal transmission line and the second sensing series.

In one embodiment of the present disclosure, wherein the peripheral area comprises a bonding area, and an end of the first signal transmission line and an end of the second signal transmission line are disposed in the bonding area.

In one embodiment of the present disclosure, the touch panel further comprises a flexible circuit board. The flexible circuit board connects the end of the first signal transmission line and the end of the second signal transmission line.

In one embodiment of the present disclosure, wherein an end of the second signal transmission line has a first contacting pad, and an end of the second sensing series has a second contacting pad, the second contacting pad aligns with the first contacting pad, and the opposite sides of the first anisotropic conducting film are respectively contacted with the first contacting pad and the second contacting pad.

In one embodiment of the present disclosure, wherein the second signal transmission line comprises a first part and a second part, the first part is substantially parallel to the first direction, and the second part is substantially parallel to the second direction.

In one embodiment of the present disclosure, wherein the first sensing substrate further comprises a decorative layer disposed in the peripheral area, the first signal transmission line and the second signal transmission line are disposed on the decorative layer.

In one embodiment of the present disclosure, the touch panel further comprises a bonding dielectric film disposed between the first sensing substrate and the second sensing substrate, and the bonding dielectric film comprises a first adhesive layer, a second adhesive layer, and a dielectric layer. The first adhesive layer is adhered to the first sensing substrate. The second adhesive layer is adhered to the second sensing substrate. The dielectric layer is disposed between the first adhesive layer and the second adhesive layer, wherein the first adhesive layer and the second adhesive layer respectively comprise an optical adhesive, and the dielectric layer comprises polyethylene terephthalate (PET).

In one embodiment of the present disclosure, the touch panel further comprises a bonding layer disposed between the first sensing substrate and the second sensing substrate.

In one embodiment of the present disclosure, wherein the first direction is orthogonal to the second direction.

In one embodiment of the present disclosure, wherein the first sensing substrate further comprises at least one third signal transmission line disposed in the peripheral area, and the third signal transmission line and the first signal transmission line are respectively disposed on the opposite sides of the first sensing substrate.

In one embodiment of the present disclosure, the touch panel further comprises a second anisotropic conducting film disposed between the first sensing substrate and the second sensing substrate, and the second anisotropic conducting film is electrically connected to the third signal transmission line and the first sensing series.

In one embodiment of the present disclosure, wherein the first sensing substrate further comprises at least one fourth signal transmission line disposed in the peripheral area, the fourth signal transmission line and the first signal transmission line are respectively electrically connected to two ends of the first sensing series.

In one embodiment of the present disclosure, wherein the first sensing series comprises a plurality of first sensor pads and a plurality of first bridges, each of the first bridges connects two adjacent first sensor pads, and the plurality of first sensor pads and the plurality of first bridges are the same film.

In one embodiment of the present disclosure, wherein the second sensing series comprises a plurality of second sensor pads and a plurality of second bridges, each of the second bridges connects two adjacent second sensor pads, and the plurality of second sensor pads and the plurality of second bridges are the same film.

### BRIEF DESCRIPTION OF THE DRAWINGS

The disclosure may be more fully understood by reading the following detailed description of the embodiment, with reference made to the accompanying drawings as follows:

FIG. 1 illustrates the exploded schematic diagram of one embodiment of the present disclosure;

FIG. 2 illustrates the top-view schematic diagram of one embodiment of the present disclosure;

FIG. 3 illustrates the top-view schematic diagram of one embodiment of the present disclosure;

FIG. 4 illustrates the top-view schematic diagram of the combined touch panel of one embodiment of the present disclosure;

FIG. 5 illustrates the schematic cross-sectional view of the bonding dielectric film of one embodiment of the present disclosure;

FIG. 6 illustrates the top-view schematic diagram of the first sensing substrate of another embodiment of the present disclosure;

FIG. 7 illustrates the top-view schematic diagram of the second sensing substrate of another embodiment of the present disclosure;

FIG. 8 illustrates the cross-section schematic diagram along the line X-X′ in FIG. 4; and

FIG. 9 illustrates the cross-section schematic diagram along the line Y-Y′ in FIG. 4.

### DETAILED DESCRIPTION

The present disclosure is described by the following specific embodiments. Those with ordinary skill in the arts can readily understand the other advantages and functions of the present invention after reading the disclosure of this specification. The present disclosure can also be implemented with different embodiments. Various details described in this specification can be modified based on different viewpoints and applications without departing from the scope of the present disclosure.

As used herein, the singular forms “a,” “an” and “the” include plural referents unless the context clearly dictates otherwise. Therefore, reference to, for example, a data sequence includes aspects having two or more such sequences, unless the context clearly indicates otherwise.

Reference will now be made in detail to the embodiments of the present disclosure, examples of which are illustrated in the accompanying drawings. Wherever possible, the same reference numbers are used in the drawings and the description to refer to the same or like parts.

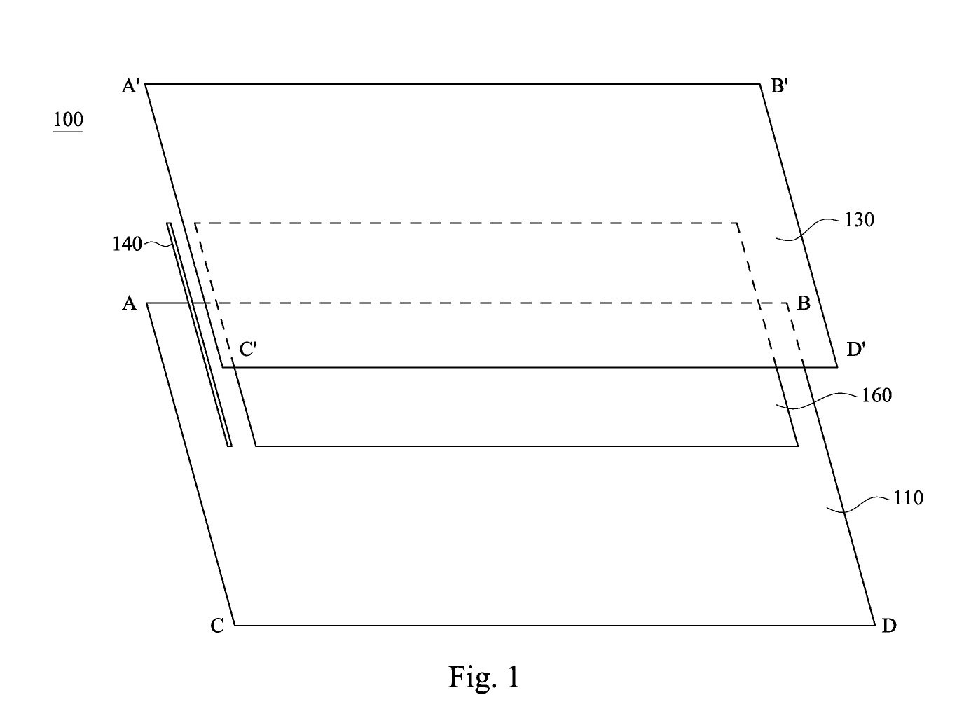

FIG. 1 illustrates the exploded schematic diagram of one embodiment of the present disclosure. The touch panel 100 comprises a first sensing substrate 110, a second sensing substrate 130 and a first anisotropic conducting film 140. The second sensing substrate 130 is opposite to the first sensing substrate 110, and the first anisotropic conducting film 140 is disposed between the first sensing substrate 110 and the second sensing substrate 130.

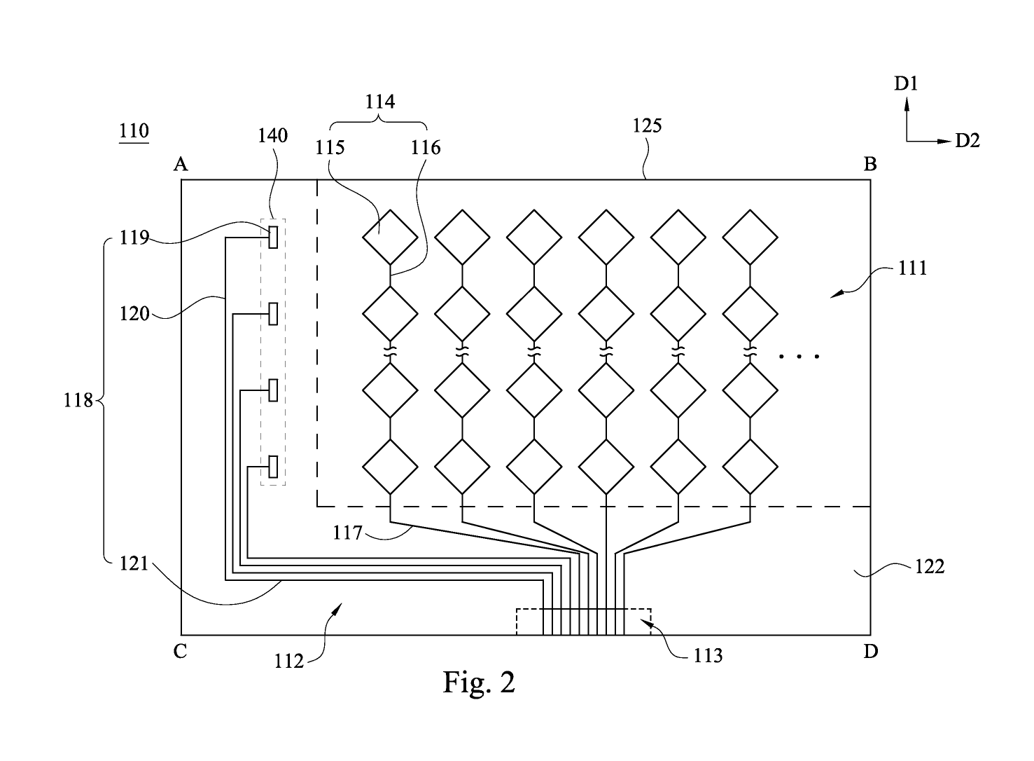

FIG. 2 illustrates the top-view schematic diagram of one embodiment of the present disclosure. The first sensing substrate 110 has a detecting region 111 and a peripheral area 112, and comprises at least one first sensing series 114, at least one first signal transmission line 117, and at least one second signal transmission line 118.

The peripheral area 112 of the first sensing substrate 110 is adjacent to the detecting region 111 of the first sensing substrate 110. The detecting region 111 is the area sensing contact coordinates, and the peripheral area 112 is the area disposing signal transmission lines. In the embodiment illustrated in FIG. 2, the peripheral area 112 is positioned at the left side and the bottom side of the detecting region 111. However, the present disclosure is not limited thereto. The peripheral area 112 may also be circle around the detecting region 111. Besides, the area ratio of the peripheral area 112 and the detecting region 111 as illustrated in FIG. 2 can be adjusted according to actual demands.

Referring to FIG. 2, the first sensing substrate 110 comprises at least one first sensing series 114, at least one first signal transmission line 117, and at least one second signal transmission line 118. The first sensing series 114 is disposed in the detecting region 111 and the first sensing series 114 extends in a first direction D1. In one embodiment of the present disclosure, first sensing series 114 comprises a plurality of first sensor pads 115 and a plurality of first bridges 116, each of the first bridges 116 connects two adjacent first sensor pads 115. Accordingly, the plurality of first sensor pads 115 is connected in series to the first sensing series 114. The first sensor pad 115 and the first bridge 116 may comprise, for example, indium tin oxide (ITO), indium zinc oxide (IZO), Al-doped ZnO (AZO), nano silvery, metal mesh or other appropriate materials. In one embodiment of the present disclosure, the plurality of first sensor pads 115 and the plurality of first bridges 116 are the same film. That is, the first sensor pad 115 and the first bridge 116 are formed by the same material and fabricated in the same process step. As illustrated in FIG. 2, in the detecting region 111, each of the first sensing series 114 are independent and separated from each other, therefore the capacitance sensing devices in the first direction D1 are constructed on the touch panel 100.

The first signal transmission line 117 and the second signal transmission line 118 are disposed in the peripheral area 112. One first signal transmission line 117 connects corresponding one first sensing series 114 to transmitting or receiving the voltage signal of the first sensing series 114. The first signal transmission line 117 and the second signal transmission line 118 may comprise, for example, gold, silver, copper, aluminum, or an alloy thereof. In one embodiment of the present disclosure, the peripheral area 112 comprises a bonding area 113, and an end of the first signal transmission line 117 and an end of the second signal transmission line 118 are disposed in the bonding area 113. In another embodiment of the present disclosure, the first signal transmission line 117 and the second signal transmission line 118 extend along with different sides of the first sensing substrate 110 to the bonding area 113, and the first signal transmission lines 117 and the second signal transmission lines 118 are gathered in the bonding area 113. Although the second signal transmission lines 118 illustrated in FIG. 2 are positioned at two different sides (bottom and left side) of the first sensing substrate 110, in other embodiment of the present disclosure, the second signal transmission lines 118 may be disposed at one side of the first sensing substrate 110. In a specific embodiment of the present disclosure, the second signal transmission line 118 comprises a first part 120 and a second part 121, the first part 120 is substantially parallel to the first direction D1, and the second part 121 is substantially parallel to the second direction D2. As illustrated in FIG. 2, the second direction D2 crosses the first direction D1, for example, the second direction D2 is orthogonal to the first direction D1. However, the present disclosure is not limited thereto.

In one embodiment of the present disclosure, the first sensing substrate 110 further comprises a decorative layer 122 disposed in the peripheral area 112, the first signal transmission line 117 and the second signal transmission line 118 are disposed on the decorative layer 122. The decorative layer 122 comprises, for example, a black or opaque resin. The decorative layer 122 is applied to shelter the first signal transmission line 117 and the second signal transmission line 118 in the peripheral area 112, so that the first signal transmission line 117 and the second signal transmission line 118 in the peripheral area 112 are not exposed after the following combination of the first sensing substrate 110 and the second sensing substrate 130. Accordingly, metal lines (the first signal transmission line 117 and the second signal transmission line 118) will not revealed in the peripheral area 112 and undermine the overall appearance of the touch panel 100.

The first sensing substrate 110 as illustrated in FIG. 2 may further comprise a first substrate 125. The first substrate 125 may comprise, for example, glass, quartz, polymethyl methacrylate (PMMA), polystyrene (PS), methyl methacrylate-co-styrene (MS) or polycarbonate (PC). However, the present disclosure is not limited thereto. The first sensing series 114, the first signal transmission line 117 and the second signal transmission line 118 are fabricated on the first substrate 125.

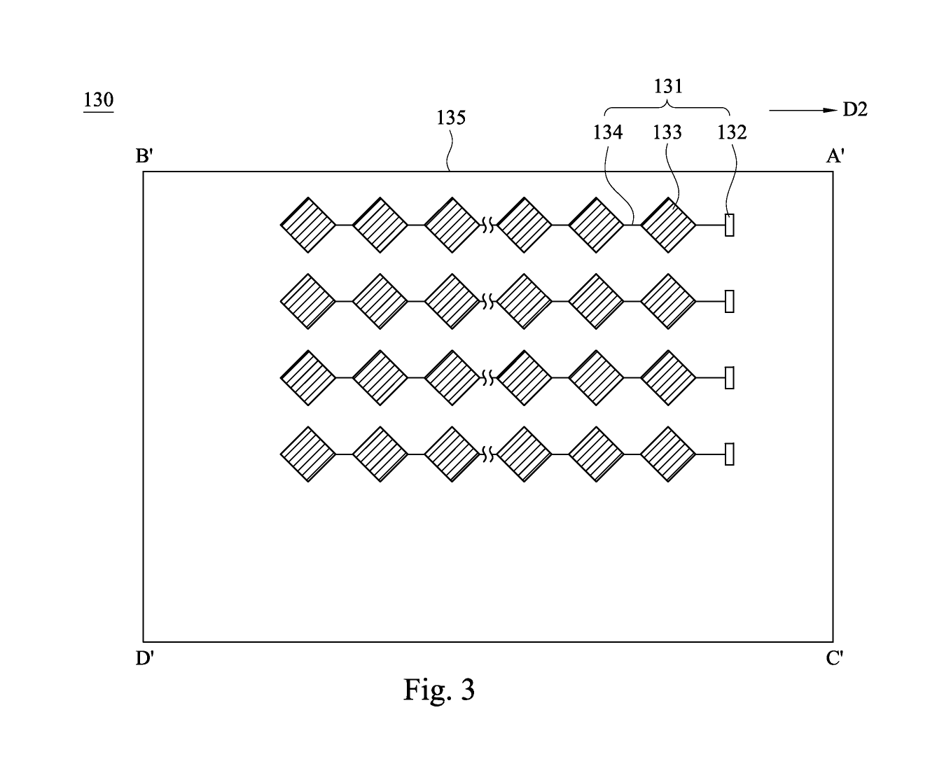

FIG. 3 illustrates the top-view schematic diagram of one embodiment of the present disclosure. The second sensing substrate 130 comprises at least one second sensing series 131, and the second sensing series 131 extends in the second direction D2. In other words, the second sensing series 131 extends in different direction form that of the first sensing series 114, and the second sensing series 131 crosses the first sensing series 114. In one embodiment of the present disclosure, the first direction D1 is orthogonal to the second direction D2. Beside, the second sensing substrate 130 illustrated in FIG. 3 may further comprise a second substrate 135. The second substrate 135 may comprise, for example, transparent polyethylene terephthalate (PET), and the second sensing series 131 is fabricated on the second substrate 135. In one embodiment of the present disclosure, the second sensing series 131 comprises a plurality of second sensor pads 133 and a plurality of second bridges 134, each of the second bridges 134 connects two adjacent second sensor pads 133. Accordingly, the plurality of second sensor pads 133 is connected in series to the second sensing series 131. The second sensor pad 133 and the second bridge 134 may comprise, for example, indium tin oxide (ITO), indium zinc oxide (IZO), Al-doped ZnO (AZO), nano silvery, metal mesh or other appropriate materials. In one embodiment of the present disclosure, the plurality of second sensor pads 133 and the plurality of second bridges 134 are the same film. That is, the second sensor pad 133 and the second bridge 134 are formed by the same material and fabricated in the same process step.

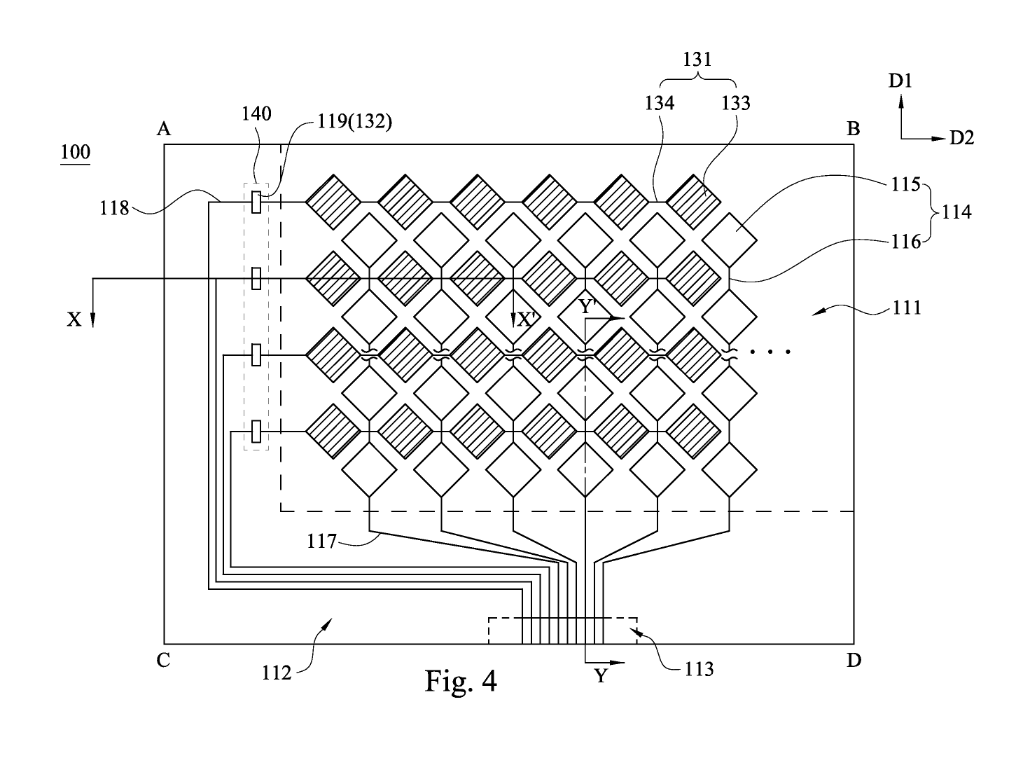

Referring to FIG. 1, FIG. 2 and FIG. 3, the first sensing substrate 110 and the second sensing substrate 130 are combined by the corresponding relationship labeled in FIG. 1. Specifically, the four corners A, B, C and D of the first sensing substrate 110 are respectively corresponded to the four corners A′, B′, C′ and D′ of the second sensing substrate 130. In one embodiment of the present disclosure, the first sensing series 114, the first signal transmission line 117, the second signal transmission line 118 are formed on the first sensing substrate 110, and the second sensing series 131 is formed on the second sensing substrate 130. Aforementioned elements are positioned inside the touch panel 100 after the first sensing substrate 110 is combined with the second sensing substrate 130. FIG. 4 illustrates the top-view schematic diagram of the combined touch panel of one embodiment of the present disclosure. The first sensor pads 115 of the first sensing series 114 are staggered to the second sensor pads 133 of the second sensing series 131.

As illustrated in FIG. 1 and FIG. 4, the first anisotropic conducting film 140 is disposed between the first sensing substrate 110 and the second sensing substrate 130. The first anisotropic conducting film 140 is positioned in the peripheral area 112 to electrically connect the second signal transmission line 118 and the second sensing series 131. In one embodiment of the present disclosure, the opposite sides of the first anisotropic conducting film 140 are respectively contacted with the second signal transmission line 118 and the second sensing series 131. More specifically, an end of the second signal transmission line 118 has a first contacting pad 119, and an end of the second sensing series 131 has a second contacting pad 132, the second contacting pad 132 substantially aligns with the first contacting pad 119. The first anisotropic conducting film 140 is disposed between the first contacting pad 119 and the second contacting pad 132. Therefore, the opposite sides of the first anisotropic conducting film 140 are respectively contacted with the first contacting pad 119 and the second contacting pad 132, so that the second sensing series 131 is electrically connected to the second signal transmission line 118 through the first anisotropic conducting film 140. Consequently, the first sensing series 114 and the second sensing series 131 on different surfaces are electrically connected by the first signal transmission line 117 and the second signal transmission line 118 on the same surface. Therefore, a flexible circuit board with only one conducting surface is required. Also worth noticing is that the first anisotropic conducting film 140 illustrated in FIG. 1 is one whole block, however, the present disclosure is not limited thereto. The first anisotropic conducting film 140 may be divided into several smaller blocks under the premise without affecting the performance of electrical connection.

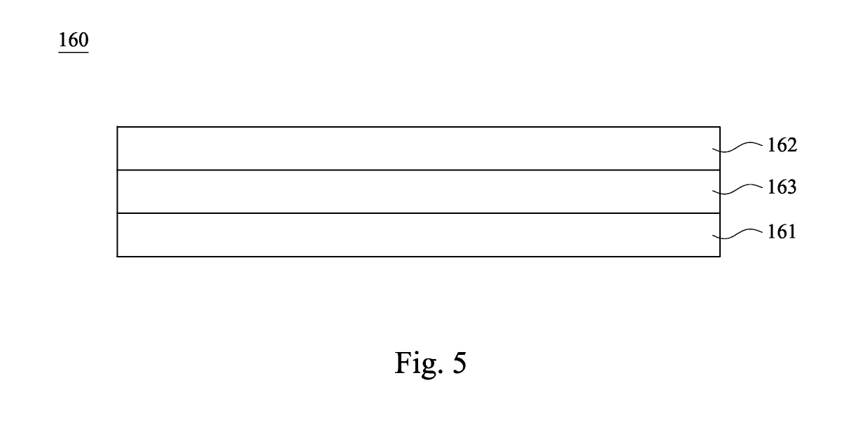

In addition, as illustrated in FIG. 1, in one embodiment of the present disclosure, the touch panel 100 further comprises a bonding dielectric film 160 disposed between the first sensing substrate 110 and the second sensing substrate 130. The bonding dielectric film 160 is the adhesive for the combination of the first sensing substrate 110 and the second sensing substrate 130, and also isolates the first sensing substrate 110 from the second sensing substrate 130. Therefore, an appropriate distance can be maintained between the first sensing substrate 110 and the second sensing substrate 130. FIG. 5 illustrates the schematic cross-sectional view of the bonding dielectric film 160 of one embodiment of the present disclosure. The bonding dielectric film 160 comprises a first adhesive layer 161, a second adhesive layer 162 and the dielectric layer 163. The first adhesive layer 161 is adhered to the first sensing substrate 110. The second adhesive layer 162 is adhered to the second sensing substrate 130. The dielectric layer 163 is disposed between the first adhesive layer 161 and the second adhesive layer 162. In one specific embodiment of the present disclosure, the first adhesive layer 161 and the second adhesive layer respectively comprise an optical adhesive, and the dielectric layer comprises polyethylene terephthalate (PET). The thickness of the first adhesive layer 161 may be 0.05 mm; the thickness of the dielectric layer 163 may be 0.125 mm; and the thickness of the second adhesive layer 162 may be 0.025 mm. However, the present disclosure is not limited thereto.

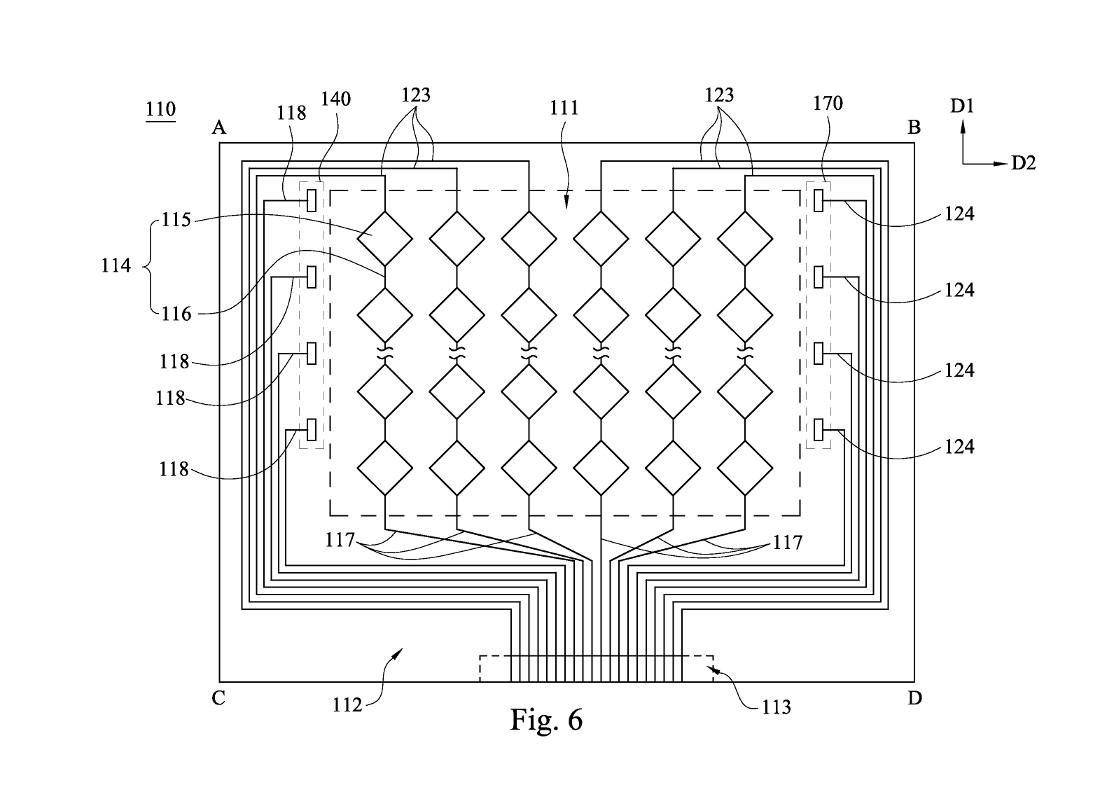

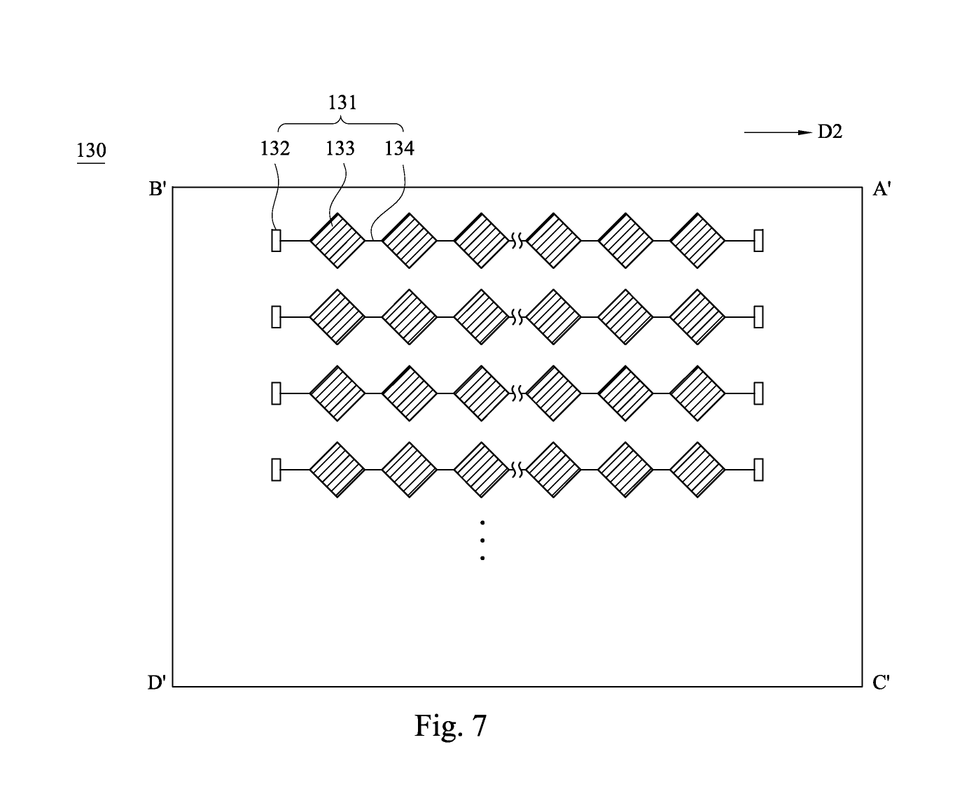

FIG. 6 and FIG. 7 respectively illustrates the top-view schematic diagram of the first sensing substrate 110 and second sensing substrate 130 of another embodiment of the present disclosure. In the present embodiment, the first sensing substrate 110 further comprises at least one third signal transmission line 123 disposed in the peripheral area 112. As illustrated in FIG. 6, the third signal transmission line 123 and the first signal transmission line 117 are respectively connect to the opposite ends of the first sensing series 114, and the third signal transmission line 123 extends to the bonding area 113.

In another embodiment of the present disclosure, the first sensing substrate 110 further comprises at least one fourth signal transmission line 124 disposed in the peripheral area 112. As illustrate in FIG. 6, the fourth signal transmission line 124 and the second signal transmission line 118 are respectively positioned at the opposite sides of the first sensing substrate 110. The fourth signal transmission line 124 and the second signal transmission line 118 respectively electrically connect to the opposite ends of the second sensing series 131 (As illustrated in FIG. 7). In the present embodiment, the touch panel 100 further comprises a second anisotropic conducting film 170 disposed between the first sensing substrate 110 and the second sensing substrate 130. Therefore, the fourth signal transmission line 124 and the second signal transmission line 118 are respectively electrically connected to the opposite ends of the second sensing series 131 through the second anisotropic conducting film 170 and the first anisotropic conducting film 140 respectively. Accordingly, the first sensing series 114 and/or the second sensing series 131 can be drive by both sides.

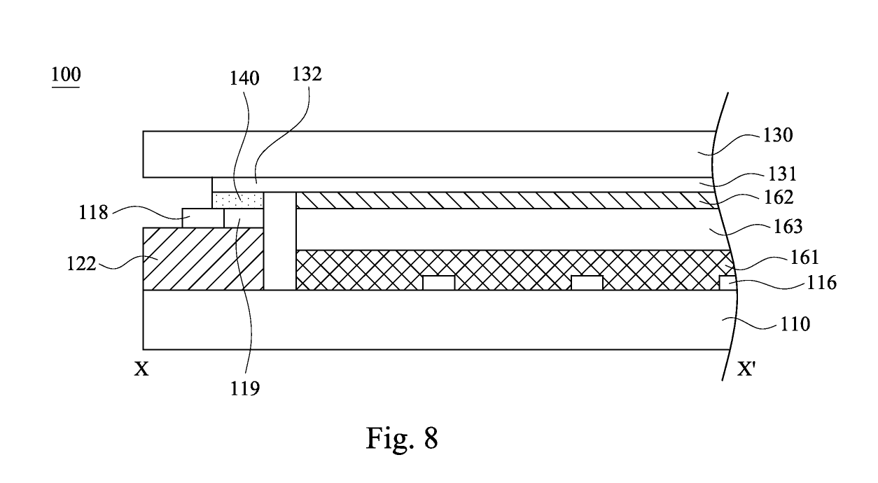

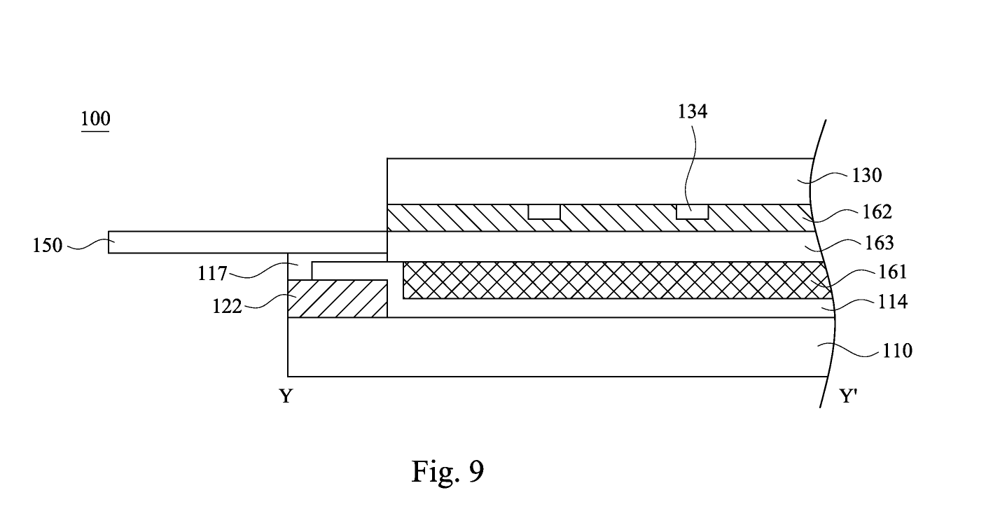

In order to further explain the structure of the combination of the first sensing substrate 110 and the second sensing substrate 130 of the touch panel 100 according to one embodiment of the present disclosure, FIG. 8 illustrates the cross-section schematic diagram along the line X-X′ in FIG. 4, and FIG. 9 illustrates the cross-section schematic diagram along the line Y-Y′ in FIG. 4.

Referring to FIG. 4 and FIG. 8, the second signal transmission line 118 of the first sensing substrate 110 contacts the lower surface of the first anisotropic conducting film 140 through the first contacting pad 119; and the second contacting pad 132 of the second sensing series 131 contacts the upper surface of the first anisotropic conducting film 140. Therefore, the second sensing series 131 is electrically connected to the second signal transmission line 118 through the first anisotropic conducting film 140. Referring to FIG. 4 and FIG. 9, the first signal transmission line 117 and the second signal transmission line 118 extend and gather in the bonding area 113. Referring to FIG. 9, according to the present embodiment, the touch panel 100 further comprises a flexible circuit board 150. The flexible circuit board 150 is bonded to the ends of the first signal transmission line 117 and the second signal transmission line 118 by single-sided lamination. Accordingly, the flexible circuit board 150 is only required to have single sided circuits, and the flexible circuit board 150 could be electrically connected to the first sensing series 114 and the second sensing series 131 which are disposed on different substrates. In other words, according to the touch panels of the embodiments of the present disclosure, only single piece of the flexible circuit board is required. By single-sided bonding the flexible circuit board to the combination of the first sensing substrate 110 and the second sensing substrate 130, signals input/output of the touch panel 100 is achieved. Therefore, the process steps are simplified and the cost of manufacturing a touch panel is reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

What is claimed is:

1. A touch panel, comprising:
a first sensing substrate having a detecting region and a peripheral area surrounding the detecting region, the first sensing substrate comprising:
at least one first sensing series disposed in the detecting region, and the first sensing series extending in a first direction;
at least one first signal transmission line disposed in the peripheral area, and connected to the first sensing series; and
at least one second signal transmission line disposed in the peripheral area;
a second sensing substrate facing the first sensing substrate, the second sensing substrate comprising a least a second sensing series, and the second sensing series extending in a second direction, wherein the second direction crosses the first direction; and
a first anisotropic conducting film disposed between the first sensing substrate and the second sensing substrate, and positioned in the peripheral area, wherein the first anisitropic conducting film is electrically connected to the second signal transmission line and the second sensing series.

2. The touch panel of claim 1, wherein the peripheral area comprises a bonding area, and an end of the first signal transmission line and an end of the second signal transmission line are disposed in the bonding area.

3. The touch panel of claim 2, further comprising a flexible circuit board, the flexible circuit board is connected to the end of the first signal transmission line and the end of the second signal transmission line.

4. The touch panel of claim 1, wherein an end of the second signal transmission line has a first contacting pad, and an end of the second sensing series has a second contacting pad, the second contacting pad aligns with the first contacting pad, and the opposite sides of the first anisotropic conducting film are respectively contacted with the first contacting pad and the second contacting pad.

5. The touch panel of claim 1, wherein the second signal transmission line comprises a first part and a second part, the first part is substantially parallel to the first direction, and the second part is substantially parallel to the second direction.

6. The touch panel of claim 1, wherein the first sensing substrate further comprises a decorative layer disposed in the peripheral area, the first signal transmission line and the second signal transmission line are disposed on the decorative layer.

7. The touch panel of claim 1, further comprising a bonding dielectric film disposed between the first sensing substrate and the second sensing substrate, and the bonding dielectric film comprising:
a first adhesive layer adhered to the first sensing substrate;
a second adhesive layer adhered to the second sensing substrate; and
a dielectric layer disposed between the first adhesive layer and the second adhesive layer, wherein the first adhesive layer and the second adhesive layer respectively comprise an optical adhesive, and the dielectric layer comprises polyethylene terephthalate (PET).

8. The touch panel of claim 1, further comprising a bonding layer disposed between the first sensing substrate and the second sensing substrate.

9. The touch panel of claim 1, wherein the first direction is orthogonal to the second direction.

10. The touch panel of claim 1, wherein the first sensing substrate further comprises at least one third signal transmission line disposed in the peripheral area, and the third signal transmission line and the first signal transmission line are respectively disposed on the opposite sides of the first sensing substrate.

11. The touch panel of claim 10, further comprising a second anisotropic conducting film disposed between the first sensing substrate and the second sensing substrate, and the second anisotropic conducting film being electrically connected to the third signal transmission line and the first sensing series.

12. The touch panel of claim 1, wherein the first sensing substrate further comprising at least one fourth signal transmission line disposed in the peripheral area, the fourth signal transmission line and the first signal transmission line are respectively electrically connected to two ends of the first sensing series.

13. The touch panel of claim 1, wherein the first sensing series comprises a plurality of first sensor pads and a plurality of first bridges, each of the first bridges connects two adjacent first sensor pads, and the plurality of first sensor pads and the plurality of first bridges are the same film.

14. The touch panel of claim 1, wherein the second sensing series comprises a plurality of second sensor pads and a plurality of second bridges, each of the second bridges connects two adjacent second sensor pads, and the plurality of second sensor pads and the plurality of second bridges are the same film.
